(19) United States
(12) Patent Application Publication
(10) Pub. No.: US 2024/0265818 A1
(43) Pub. Date: Aug. 8, 2024

(54) SYSTEM AND METHOD FOR REDUCED-ENGINE TAXIING OPERATION

(71) Applicant: The Boeing Company, Arlington, VA (US)

(72) Inventors: Samantha A. Schwartz, Castle Pines, CO (US); Garoe Gonzalez, Frankfurt (DE)

(73) Assignee: The Boeing Company, Arlington, VA (US)

(21) Appl. No.: 18/163,677

(22) Filed: Feb. 2, 2023

(51) Int. Cl. G08G 5/06; B64D 43/00; G08G 5/00

(52) U.S. Cl. CPC G08G 5/065; B64D 43/00; G08G 5/0073

(57) ABSTRACT

A system and method are provided for an aircraft at an airport surrounded by an environment, the aircraft having a first engine and a second engine wherein the second engine is to be started after the first engine. The system and method are configured for determining a minimum amount of warm-up time needed for starting the second engine to meet predetermined start-up requirements for the second engine, based on one or more of engine-related information relating to the second engine, aircraft-related information relating to the aircraft, airport-related information relating to the airport, and environment-related information relating to the environment, and producing an alert based on the minimum amount of warm-up time needed.

### INTRODUCTION

This disclosure relates generally to reduced-engine taxiing operations, and more particularly to systems and methods for reduced-engine taxiing operations for aircraft having at least a first engine and a second engine.

When conducting taxiing operations with aircraft having two or more engines, it is customary practice to perform a procedure known as a reduced-engine taxiing operation (“RETO”) in which only one engine is used for taxiing on the tarmac. This is done because only one engine is required to propel the aircraft along the tarmac, such as from a terminal gate to a departing runway, and such single-engine operation saves more fuel than using more than one engine.

It is also customary practice in RETO situations for the pilot to guess at or estimate when to start the second engine. For example, under normal conditions, the pilot might estimate that the second engine may require three minutes of running time in order to warm up the second engine. In such a case, the pilot may estimate when there is about three minutes left until the time when both engines need to be ready for being powered up for departure.

### SUMMARY

According to one embodiment, a method for an aircraft at an airport surrounded by an environment, the aircraft having a first engine and a second engine wherein the second engine is to be started after the first engine. The method includes determining a minimum amount of warm-up time needed for starting the second engine to meet predetermined start-up requirements for the second engine, based on one or more of engine-related information relating to the second engine, aircraft-related information relating to the aircraft, airport-related information relating to the airport, and environment-related information relating to the environment, and producing an alert based on the minimum amount of warm-up time needed.

The one or more of engine-related information, aircraft-related information, airport-related information and environment-related information may include one or both of historical information and real-time information. Further, one or both of the engine-related information and the aircraft-related information may include one or both of instantial information (relating to the second engine itself or to the aircraft itself) and categorical information (relating to an engine category to which the second engine belongs or to an aircraft category to which the aircraft belongs).

The start-up requirements for the second engine may include one or more of a minimum engine temperature, a minimum fuel temperature, a minimum oil temperature and a minimum oil pressure. The alert may be one or more of a visual indication on a display device, an auditory indication through an auditory device, and a vibratory indication from a vibrational device. The alert may be one or more of an indicator of the minimum amount of warm-up time needed, a countdown based on the minimum amount of warm-up time needed, and a prompt to start the second engine. The alert may be configured for being provided for a pilot of the aircraft in one or more of a display device within a cockpit of the aircraft or in a heads-up display of the pilot, an auditory device within the cockpit or in a headset of the pilot, and a vibrational device in a steering yoke, a throttle lever, a control stick, a control pedal, a footrest or a seat within the cockpit.

The method may further include receiving or accessing a first set of information relating to the one or more of engine-related information, aircraft-related information, airport-related information and environment-related information. The method may also include receiving or accessing a second set of information relating to the start-up requirements. The method may additionally include starting the first engine, as well as conducting a reduced-engine taxiing operation of the aircraft utilizing the first engine. After the step of producing the alert based on the minimum amount of warm-up time needed, the method may include starting the second engine. Moreover, the method may include determining whether a reduced-engine taxiing operation of the aircraft is permissible based on standard operating procedures of the airport.

According to another embodiment, a method is provided for performing a reduced-engine taxiing operation of an aircraft at an airport surrounded by an environment, the aircraft having a first engine and a second engine wherein the second engine is to be started after the first engine. The method includes: (i) starting the first engine; (ii) conducting a reduced-engine taxiing operation of the aircraft utilizing the first engine; (iii) receiving or accessing a first set of information relating to the one or more of engine-related information relating to the second engine, aircraft-related information relating to the aircraft, airport-related information relating to the airport and environment-related information relating to the environment; (iv) receiving or accessing a second set of information relating to predetermined start-up requirements for the second engine; (v) determining a minimum amount of warm-up time needed for starting the second engine to meet the predetermined start-up requirements for the second engine, based on one or more of the engine-related information, aircraft-related information, airport-related information, and environment-related information; and (vi) producing an alert based on the minimum amount of warm-up time needed.

In this embodiment, the one or more of engine-related information, aircraft-related information, airport-related information and environment-related information may include one or both of historical information and real-time information. Additionally, one or both of the engine-related information and the aircraft-related information may include one or both of instantial information (relating to the second engine itself or to the aircraft itself) and categorical information (relating to an engine category to which the second engine belongs or to an aircraft category to which the aircraft belongs). The start-up requirements for the second engine may include one or more of a minimum engine temperature, a minimum fuel temperature, a minimum oil temperature and a minimum oil pressure, and the alert may include one or more of a visual indication on a display device, an auditory indication through an auditory device, and a vibratory indication from a vibrational device, and one or more of an indicator of the minimum amount of warm-up time needed, a countdown based on the minimum amount of warm-up time needed and a prompt to start the second engine.

According to yet another embodiment, a system is provided for supporting a taxiing operation of an aircraft at an airport surrounded by an environment, the aircraft having a first engine and a second engine wherein the second engine is to be started after the first engine. The system includes: (i) a taxi operation support module having a memory configured to store an instruction set and processing circuitry configured to access the memory and execute the instruction set to (a) determine a minimum amount of warm-up time needed for starting the second engine to meet predetermined start-up requirements for the second engine, based on one or more of engine-related information, aircraft-related information, airport-related information, and environment-related information, and (b) produce an alert signal based on the minimum amount of warm-up time needed; and (ii) an indication module operatively connected with the taxi operation support module and configured to receive the alert signal and produce an alert based on the alert signal.

The taxi operation support module may be further configured to receive or access a first set of information relating to the one or more of engine-related information, aircraft-related information, airport-related information and environment-related information, and receive or access a second set of information relating to the start-up requirements. The alert may include one or more of a visual indication on a display device, an auditory indication through an auditory device, and a vibratory indication from a vibrational device, and one or more of an indicator of the minimum amount of warm-up time needed, a countdown based on the minimum amount of warm-up time needed and a prompt to start the second engine.

The above features and advantages, and other features and advantages, of the present teachings are readily apparent from the following detailed description of some of the best modes and other embodiments for carrying out the present teachings, as defined in the appended claims, when taken in connection with the accompanying drawings.

### BRIEF DESCRIPTION OF THE DRAWINGS

FIG. 1 is a block diagram of an aircraft.

FIG. 2 is a schematic plan view of an airport at which the aircraft of FIG. 1 is located.

FIG. 3 is a block diagram of a system for supporting a taxiing operation of the aircraft of FIG. 1 at the airport of FIG. 2.

FIG. 4 is a flowchart for a method for performing a taxiing operation of the aircraft of FIG. 1 at the airport of FIG. 2.

### DETAILED DESCRIPTION

Referring now to the drawings, wherein like numerals indicate like parts in the several views, a system 120 for supporting a taxiing operation 10 of an aircraft 12 having a first engine 14 and a second engine 16, and a method 200 for performing the taxiing operation 10, are shown and described herein. In both the system 120 and the method 200, the second engine 16 is to be started after the first engine 14.

In contrast with the abovementioned customary practices, the system 120 and method 200 of the present disclosure address the technical problem of knowing when is the optimum time to start up a second engine 16 during a RETO 18 situation, by the technical effect of determining or calculating a minimum amount of warm-up time needed 132 for the second engine 16 based on specific criteria, thereby providing significant benefits and technical advantages which are not taught or suggested by other known approaches. These benefits and technical advantages include freeing up the pilot from the effort, distraction and stress of figuring out when is the best time to start the second engine 16, removing a potential source of pilot error, and optimizing fuel savings.

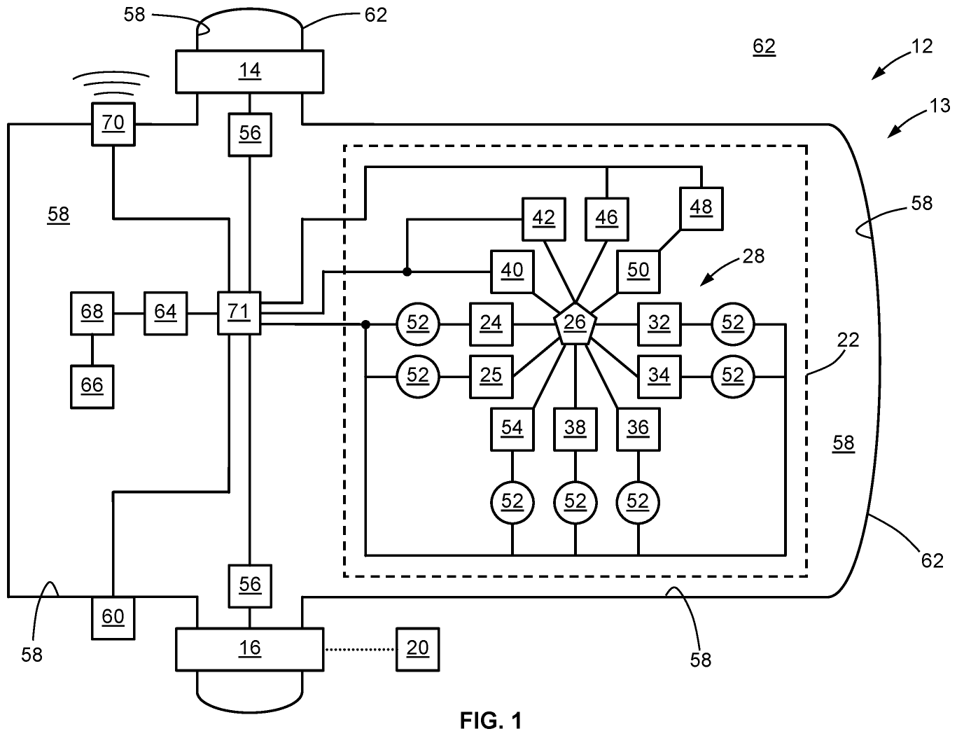

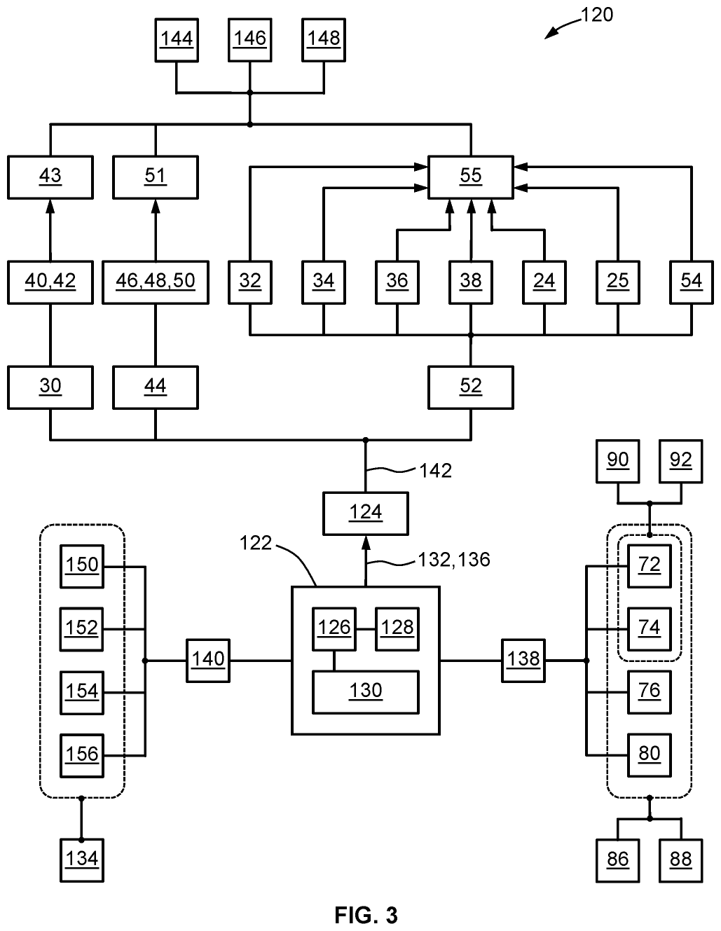

FIGS. 1 and 3 show block diagrams of an aircraft 12 and a system 120 used onboard or in conjunction with the aircraft 12, respectively, for supporting a taxiing operation 10 of the aircraft 12, such as a reduced-engine taxiing operation (“RETO”) 18. The aircraft 12 may be a fixed-wing airplane belonging to an aircraft category 13, which is a categorization, grouping or population of individual aircrafts that share common characteristics, such as manufacturer, model number, number and type of engines, etc. The aircraft 12 has at least a first engine 14 and a second engine 16, with the aircraft 12 being capable of performing a RETO 18. The second engine 16 (and optionally the first engine 14 as well) belongs to an engine category 20, which is a categorization, grouping or population of individual engines sharing common characteristics, such as manufacturer, model number, engine displacement, etc.

It may be noted that while individual engines within an engine category 20 will have certain characteristics that are the same for all the engines in that category 20, there may be some characteristics which vary from one individual engine to another, such as age, number of service hours and maintenance/repair history. Similarly, while individual aircrafts within an aircraft category 12 will have certain characteristics that are the same for all the aircrafts in that category 12, there may be some characteristics which vary from one individual aircraft to another, such as age, number of service hours, maintenance/repair history and the like.

The aircraft 12 includes a cockpit 22 containing a seat 24 in which a pilot 26 may sit. The cockpit 22 may also include various control devices 28 and display devices 30 with which the pilot 26 may interact. For example, the control devices 28 may include a steering yoke 32, a throttle lever 34, a control stick 36 (which may include or be called a control lever and/or a joystick) and one or more control pedals 38 (such as for controlling the rudder and/or brakes). The display devices 30 may include a heads-up display (“HUD”) 40 which the pilot 26 may 26 may wear in the form of goggles, glasses, a visor, etc., as well as one or more display screens 42 mounted within the cockpit 22. The HUD 40 and display screens 42 may be wired or wireless. Each of the display devices 26 may be configured for displaying one or more visual indications 43 thereon. These visual indications 43 may be in the form of text, icons, symbols or the like, which may be shown in special renderings such as special colors, large text and/or in a flashing, pulsing, moving or rotating format in order to attract a pilot's attention.

The cockpit 22 may additionally include one or more auditory devices 44 which are configured to emit sound(s) for the benefit and/or the attention of the pilot 26. For example, the auditory devices 44 may include a speaker/loudspeaker 46 mounted within the cockpit 22, and/or a speaker 48 mounted in a headset 50 which the pilot 26 may wear. (As used here, the “headset” may include an in-the-ear, on-the-ear or around-the-ear earset, a set of headphones and a set of one or more earplugs/earphones.) The speakers 46, 48 and headset 50 may be wired or wireless. Each of the auditory devices 44 may be configured for emitting one or more auditory indications 51 therefrom. These auditory indications 51 may be sounds in the form of beeps, chirps, speech or the like, which may be emitted in special renderings such as special sounds, increased volume and/or in a pulsing or undulating auditory format in order to attract a pilot's attention.

The cockpit 22 may further include one or more vibrational devices 52 which are configured to emit vibrations, buzzes or the like for the benefit and/or the attention of the pilot 26. For example, the vibrational device 52 may be a piezo-electric element which converts an electrical signal into mechanical vibration. These vibrational devices 52 may be attached to or embedded within one or more of the steering yoke 32, the throttle lever 34, a control lever/control stick/joystick 36, the one or more control pedals 38, a footrest 54 (including a footrest area in the footwell of the cockpit 22), the pilot's seat 24, and any other suitable location or device 25 within the cockpit 22. In addition to producing vibrations which the pilot 26 may feel, the vibrational device 52 may optionally also be capable of producing one or more sounds which the pilot 26 is capable of hearing. Each of the vibrational devices 52 may be configured for emitting one or more vibratory indications 55 therefrom. These vibratory indications 55 may be vibrations, pulses, buzzes or the like, which may be emitted in special renderings such as special sequences or patterns, or pulses that are rising, falling, undulating, abrupt, etc., in order to attract a pilot's attention.

Each of these display devices 30, auditory devices 44 and vibratory devices 52 may be used to provide visual indications 43, auditory indications 51 and vibrational indications 55, respectively, so as to provide an alert 142 to the pilot 26 regarding when the optimum time to start the second engine 16 is, as described in more detail below.

The aircraft 12 may include one or more internal sensors 56 located within the interior 58 of the aircraft 12, one or more external sensors 60 located on the exterior 62 of the aircraft 12, one or more accessing/processing circuits 64 within the interior 62 of the aircraft 12 which are configured to access or retrieve stored information 66 from a storage medium 68 located within the interior 58 of the aircraft 12, and/or one or more transceivers 70 which in whole or in part may be located within the interior 58 of the aircraft 12 and/or on the exterior 62 of the aircraft 12. These sensors 56, 60, circuits 64 and transceivers 70 may be controlled by one or more controllers 71 for handling the storage, retrieval and flow of signals and information among these and other devices aboard the aircraft 12. Note that as used herein, the “interior” 58 of the aircraft 12 includes locations that are within the cockpit 22, within the passenger/cargo areas, within the engines 14, 16 and anywhere within the entirety of the aircraft 12 and which is not directly exposed to the outer atmosphere outside the aircraft 12. Similarly, the “exterior” 62 of the aircraft 12 includes all other locations that are not within the interior 58, such as any locations on or outside of the outer skin or outer boundary surfaces of the aircraft 12, and any locations that are directly exposed to the outer atmosphere outside the aircraft 12. Further, note that while FIG. 1 shows the accessing/processing circuit 64, the stored information 66, the storage medium 68, a portion of the transceiver 70 and the controller 71 as being located within the interior 58 of the aircraft 12 but outside the cockpit 22, this is merely for illustration purposes, as these elements may also be located within the cockpit 22.

The internal sensor(s) 56, the external sensor(s) 60, the accessing/processing circuit(s) 64 and the transceiver(s) 70 may be configured to sense or access various phenomena, characteristics, data and/or signals which convey various types of information. This information may include engine-related information 72 relating to the second engine 16 (and/or to the engine category 20 to which the second engine 16 belongs), aircraft-related information 74 relating to the aircraft 12 (which may optionally include or exclude engine-related information 72), airport-related information 76 relating to the airport 78 at which the aircraft 12 is located, and/or environment-related information 80 relating to the outside environment 82 in which the airport 78 is located. For example, one or more internal sensors 56 and/or one or more external sensors 60 may be operatively associated with each engine 14, 16 in order to sense various engine-related information 72, such as the engine temperature, oil temperature and oil pressure for each engine 14, 16. Environment-related information 80 such as the outside air temperature, barometric pressure, humidity, dew point, wind speed, wind direction, visibility and the like may be sensed by one or more external sensors 60 and/or such information may be received onboard the aircraft 12 by one or more transceivers 70 (e.g., radios) from an external database, service or source 84. Such external databases, services or sources 84 may be commercial information sources that are encrypted, password-protected and subscription-based, or they may be information sources that are publicly available and free-of-charge. These external databases, services or sources 84 may be located on the premises of the airport 78, or they may be located some distance away from the premises of the airport 78.

As illustrated by the large dashed rounded rectangle at the lower-right of FIG. 3, the set of data and information making up the engine-related information 72, the aircraft-related information 74, the airport-related information 76 and the environment-related information 80 may include one or both of historical information 86 (which has been accumulated over time before a current moment) and real-time information 88 (which is sensed or accessed at the current moment in real time). Historical information 86 may be stored in the cloud, and may be accessible by the aircraft 12 from an external database, service or source 84 via a transceiver 70. Alternatively, the historical information 86 may be stored in the storage media 68 among the stored information 66, which may be accessible via the accessing/processing circuit 64. Additionally, historical information 86 may be received from an external database, service or source 84 by the transceiver 70 and stored as stored information 66 in the storage medium 68 with the aid of the controller 71.

As illustrated by the small dashed rounded rectangle at the lower-right of FIG. 3, the engine-related information 72 and the aircraft-related information 74 may each include one or both of instantial information 90, relating to the second engine 16 itself or to the aircraft 12 itself, and categorical information 92, relating to the engine category 20 to which the second engine 16 belongs or to the aircraft category 13 to which the aircraft 12 belongs. In other words, the engine-related information 72 may include instantial information 90 relating to the second engine 16 itself, and/or categorical information 92 relating to the engine category 20 to which the second engine 16 belongs. Similarly, the aircraft-related information 74 may include instantial information 90 relating to the individual aircraft 12 itself, and/or categorical information 92 relating to the aircraft category 13 to which the aircraft 12 belongs. It may be noted that while categorical information 92 definitionally relates to an aircraft category 13 or to an engine category 20, such information 92 may be viewed as also indirectly relating to an individual aircraft 12 or to an individual second engine 16, since the individual aircraft 12 or individual second engine 16 belongs to the respective aircraft category 13 or engine category 20.

The internal sensors 56, external sensors 60, accessing/processing circuits 64 and transceivers 70 may be utilized (optionally with the aid of the controller 71) to sense or access the various types of historical information 86, real-time information 88, instantial information 90 and categorical information 92 mentioned above.

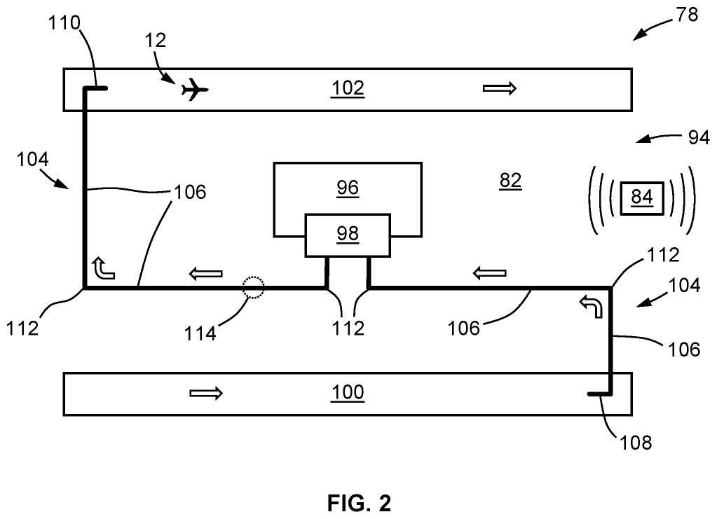

FIG. 2 shows a schematic plan view of an airport 78 at which the aircraft 12 may be located. The airport 78 is located within a surrounding environment 82, which may have a geographical location with local weather conditions. For example, the environment 82 may have a municipal, corporate or private address with latitude and longitude coordinates and an elevation above sea level, with the environment 82 also having local readings of air temperature, barometric pressure, relative humidity, dew point, wind speed, wind direction, visibility and the like.

The airport 78 may operate and be governed by a set of standard operating procedures (“SOPs”) 94, which may be a combination of rules, restrictions, permissions and guidelines promulgated by federal, state and/or local agencies for the safe operation of airport facilities. The airport 78 may include one or more terminals 96 each having one or more respective gates 98. The airport 78 additionally includes one or more arriving runways 100 and one or more departing runways 102, with a network of taxiways 104 directly or indirectly connecting each gate 98 with at least one arriving runway 100 and at least one departing runway 102. The network of taxiways 104 may include one or more taxiway segments 106, one or more ascending ramps or segments 108 (which rise in elevation), one or more descending ramps or segments 110 (which fall in elevation), one or more turns 112 and one or more divots 114 in the runways 100, 102 and/or in the taxiways 104. Note that while an ascending ramp or segment 108 is shown at the junction of one taxiway segment 106 and the arriving runway 100, and a descending ramp or segment 110 is shown at the junction of another taxiway segment 106 and the departing runway 102, such ramps 108, 110 may occur at other locations as well. Additionally, the runways 100, 102 and taxiways 104 may have various combinations of banking and/or crowning on their respective top surfaces.

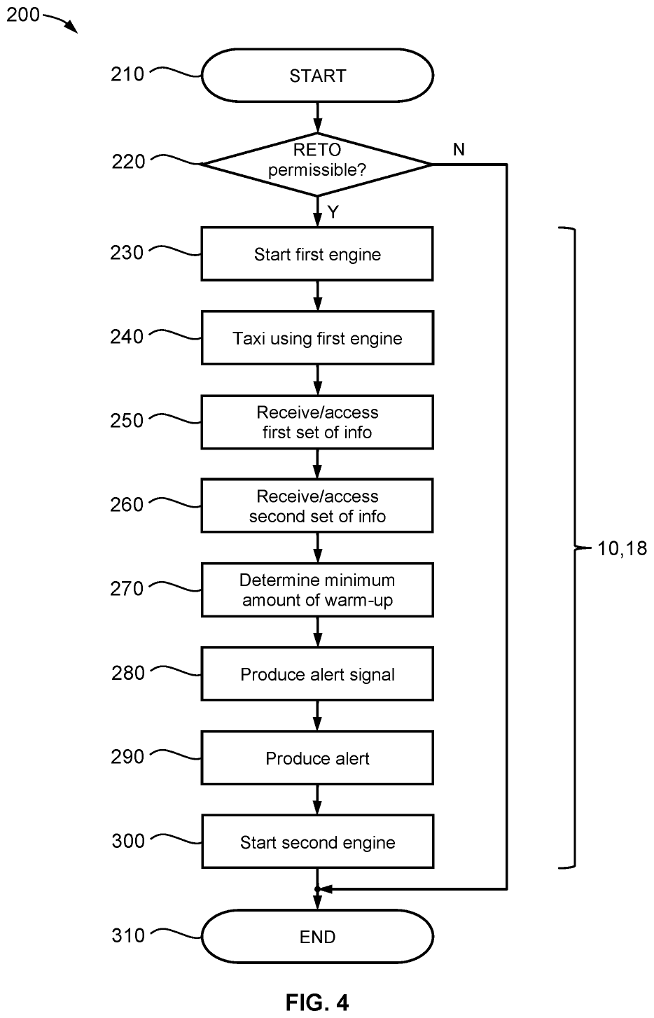

FIG. 3 shows a block diagram of a system 120 for supporting a taxiing operation 10 of an aircraft 12, and FIG. 4 shows a flowchart for a method 200 for performing the taxiing operation 10. In both the system 120 of FIG. 3 and the method 200 of FIG. 4, the aircraft 12 may be at an airport 78 surrounded by an environment 82, with the aircraft 12 having a first engine 14 and a second engine 16, and the taxiing operation 10 may be a RETO 18.

As illustrated in the block diagram of FIG. 3, the system 120 includes a taxi operation support module 122 and an indication module 124 operatively connected with the taxi operation support module 122. The taxi operation support module 122 includes a memory 126 configured to store an instruction set 128, and processing circuitry 130 configured to access the memory 126 and to retrieve and execute the instruction set 128. The execution of the instruction set 128 by the processing circuitry 130 is configured so as to be effective to determine a minimum amount of warm-up time needed 132 for starting the second engine 16 in order to meet predetermined start-up requirements 134 for the second engine 16, and to produce an alert signal 136 based on the minimum amount of warm-up time needed 132. This determination of the minimum amount of warm-up time needed 132 for the second engine 16 is based on one or more of engine-related information 72, aircraft-related information 74, airport-related information 76, and environment-related information 80. For example, the instruction set 128 may include one or more algorithms that utilize the engine-related information 72, the aircraft-related information 74, the airport-related information 76, and/or the environment-related information 80 as inputs for the one or more algorithms.

The taxi operation support module 122 may be configured to receive or access a first set of information 138 relating to the engine-related information 72, the aircraft-related information 74, the airport-related information 76 and/or the environment-related information 80, and to receive or access a second set of information 140 relating to the start-up requirements 134. As illustrated by the large dashed rounded rectangle at the lower-left of FIG. 3, the predetermined start-up requirements 134 may include a minimum engine temperature 150, a minimum fuel temperature 152, a minimum oil temperature 154, a minimum oil pressure 156 and/or other suitable requirements. The taxi operation support module 122 may receive or access the first and second sets of information 138, 140 via the internal sensors 56, the external sensors 60, the accessing/processing circuits 64 and/or the transceivers 70. (For example, some portions of this information 138, 140 may be sensed by the internal or external sensors 56, 60, and other portions of the information 138, 140 may be accessed via the accessing/processing circuits 64 (e.g., from the stored information 66 on the storage medium 68) or via the transceivers 70 (e.g., from an external database, service or source 84). Additionally, the indication module 124 is configured to receive the alert signal 136 and produce an alert 142 based on the alert signal 136. The alert signal 136 may be an analog signal, a digital signal or a combined analog and digital signal.

When the alert signal 136 is produced by the taxi operation support module 122 and is received by the indication module 124, the indication module 124 sends one or more other signals (which are different from the alert signal 136) to one or more display device 30, one or more auditory device 44 and/or one or more vibrational device 52, so as to produce one or more visual indications 43, one or more auditory indication 51 and/or one or more vibratory indications 55, respectively. These various indications 43, 51, 55 provide information to the pilot 26 regarding when to start the second engine 16.

The alert 142 may include or take the form of a visual indication 43 on a display device 30, an auditory indication 51 through an auditory device 44, and/or a vibratory indication 55 from a vibrational device 52. The alert 142 may also include or take the form of an indicator 144 of the minimum amount of warm-up time needed 132 for the second engine 16, a countdown 146 based on the minimum amount of warm-up time needed 132, and/or a prompt 148 to start the second engine 16. Each of the visual, auditory and vibratory indications 43, 51, 55 may be provided in the form of a respective indicator 144, a respective countdown 146 or a respective prompt 148. It may be noted that the alert 142 may be presented in multiple forms or formats and at more than one singular time.

For example, after the minimum amount of warm-up time needed 132 for the second engine 16 has been determined, the taxi operation support module 122 produces an alert signal 136 that is indicative of the minimum amount of warm-up time needed 132. This alert signal 136 is received by the indication module 124, and the indication module 124 then produces an alert 142 which, like the alert signal 136, is indicative of the minimum amount of warm-up time needed 132. The alert 142 may optionally include a continuation of the alert 142 until the pilot 26 acknowledges the alert 142, such as by pressing a designated button or by starting the second engine 16.

In one example, the alert 142 may be presented at two times: i.e., at a first time, to indicate the start of a countdown 146 until an optimum time to start the second engine 16, and at a second time at the end of the countdown 146 to indicate that the optimum time to start the second engine 16 has arrived. For instance, at the first time, a combination of three different forms of the alert 142 may be simultaneously triggered: (i) an auditory indication 51 in the form of three short beeps may be emitted from an auditory device 44 (e.g., in a cockpit loudspeaker 46 and in a headset speaker 48); (ii) a flashing series of numbers showing a countdown 146 may be displayed as a visual indication 43 on a display device 30 (e.g., in the HUD 40 and on one or more display screens 42); and (iii) a vibratory indication 55 in the form of three short vibrational pulses may be emitted from one or more vibrational devices 52 (e.g., by piezo-electric elements embedded in the steering yoke 32, the throttle lever 34 and the control stick 36). Then, at the second time (i.e., at the end of the countdown 146, when it is time to commence start-up of the second engine 16), another combination of three different forms of the alert 142 may be triggered: (iv) an auditory indication 51 in the form of one long beep may be emitted from an auditory device 44 (e.g., in a cockpit loudspeaker 46 and in a headset speaker 48); (v) the flashing series of numbers showing the countdown 146 may disappear and be replaced by a flashing icon displayed as a visual indication 43 on a display device 30 (e.g., in the HUD 40 and on one or more display screens 42); and (vi) a vibratory indication 55 in the form of one long vibrational pulse may be emitted from one or more vibrational devices 52 (e.g., by piezo-electric elements embedded in the steering yoke 32, the throttle lever 34 and the control stick 36). In this example, at the first time, the timing and cadence of the three short beeps may match the timing and cadence of the three short vibrational pulses, and at the second time, the timing and duration of the one long beep may match the timing and duration of the one long vibrational pulse. Other combinations of visual, auditory and vibratory indications 43, 51, 55 and indicators 144, countdowns 146 and prompts 148 utilizing the various control devices 28, display devices 30, auditory devices 44 and vibrational devices 52 are also possible.

As illustrated in the flowchart of FIG. 4, the method 200 may include multiple steps between a “START” step at block 210 and an “END” step at block 310. At block 270, a minimum amount of warm-up time needed 132 may be determined for starting the second engine 16 in order to meet predetermined start-up requirements 134 for the second engine 16, based on one or more of engine-related information 72 relating to the second engine 16, aircraft-related information 74 relating to the aircraft 12, airport-related information 76 relating to the airport 78, and environment-related information 80 relating to the environment 82. For example, the start-up requirements 134 may include one or more of a minimum engine temperature 150, a minimum fuel temperature 152, a minimum oil temperature 154 and a minimum oil pressure 156. Once the minimum amount of warm-up time needed 132 for the second engine 16 is determined, then at block 290, an alert 142 is produced based on the minimum amount of warm-up time needed 132. Optionally, before producing the alert 142 at block 290, the method 200 may also include, at block 280, a step of producing an alert signal 136 based on the minimum amount of warm-up time needed 132.

The alert 142 may be one or more of a visual indication 43 on a display device 30, an auditory indication 51 through an auditory device 44, and a vibratory indication 55 from a vibrational device 52. The alert 142 may be one or more of an indicator 144 of the minimum amount of warm-up time needed 132, a countdown 146 based on the minimum amount of warm-up time needed 132, and a prompt 148 to start the second engine 16. The alert 142 may be configured for being provided for a pilot 26 of the aircraft 12 in one or more of a display device 30 within a cockpit 22 of the aircraft 12 or in an HUD 40 of the pilot 26, an auditory device 44 within the cockpit 22 or in a headset 50 of the pilot 26, and a vibrational device 52 in a steering yoke 32, a throttle lever 34, a control stick 36, a control pedal 38, a footrest 54 or a seat 24 within the cockpit 22.

The method 200 may also include, at block 220, determining whether a RETO 18 of the aircraft 12 is permissible based on SOPs 94 of the airport 78. If a RETO 18 is permissible per the airport's SOPs 94, then the process flow may proceed along the path marked “Y” (indicating “yes”); however, if a RETO 18 is not permissible per the airport's SOPs 94, then the process flow may proceed to block 310 along the path marked “N” (indicating “no”).

The method 200 may additionally include, at block 230, starting the first engine 14, as well as, at block 240, conducting a RETO 18 of the aircraft 12 utilizing the first engine 14. The method 200 may further include, at block 250, receiving or accessing a first set of information 138 relating to the one or more of engine-related information 72, aircraft-related information 74, airport-related information 76 and environment-related information 80. The method 200 may also include, at block 260, receiving or accessing a second set of information 140 relating to the start-up requirements 134. After the step of producing the alert 142 based on the minimum amount of warm-up time needed 132 at block 290, the method 200 may also include, at block 300, a step of starting the second engine 16.

According to another embodiment, a method 200 is provided for performing a RETO 18 of an aircraft 12 at an airport 78 surrounded by an environment 82, with the aircraft 12 having a first engine 14 and a second engine 16. In this embodiment, the method 200 includes: (i) at block 230, starting the first engine 14; (ii) at block 240, conducting a RETO 18 of the aircraft 12 utilizing the first engine 14; (iii) at block 250, receiving or accessing a first set of information 138 relating to the one or more of engine-related information 72 relating to the second engine 16, aircraft-related information 74 relating to the aircraft 12, airport-related information 76 relating to the airport 78, and environment-related information 80 relating to the environment 82; (iv) at block 260, receiving or accessing a second set of information 140 relating to predetermined start-up requirements 134 for the second engine 16; (v) at block 270, determining a minimum amount of warm-up time needed 132 for starting the second engine 16 to meet the predetermined start-up requirements 134 for the second engine 16, based on one or more of the engine-related information 72, aircraft-related information 74, airport-related information 76, and environment-related information 80; and (vi) at block 290, producing an alert 142 based on the minimum amount of warm-up time needed 132.

In this embodiment, the engine-related information 72, the aircraft-related information 74, the airport-related information 76 and/or the environment-related information 80 may include one or both of historical information 86 and real-time information 88. Additionally, one or both of the engine-related information 72 and the aircraft-related information 74 may include one or both of instantial information 90 (relating to the second engine 16 itself or to the aircraft 12 itself) and categorical information 92 (relating to an engine category 20 to which the second engine 16 belongs or to an aircraft category 13 to which the aircraft 12 belongs). The start-up requirements 134 for the second engine 16 may include one or more of a minimum engine temperature 150, a minimum fuel temperature 152, a minimum oil temperature 154 and a minimum oil pressure 156, and the alert 142 may include one or more of a visual indication 43 on a display device 30, an auditory indication 51 through an auditory device 44, and a vibratory indication 55 from a vibrational device 52, and one or more of an indicator 144 of the minimum amount of warm-up time needed 132, a countdown 146 based on the minimum amount of warm-up time needed 132 and a prompt 148 to start the second engine 16.

While various steps of the method 200 have been described as being separate blocks, and various functions of the system 120 have been described as being separate modules or elements, it may be noted that two or more steps may be combined into fewer blocks, and two or more functions may be combined into fewer modules or elements. Similarly, some steps described as a single block may be separated into two or more blocks, and some functions described as a single module or element may be separated into two or more modules or elements. Additionally, the order of the steps or blocks described herein may be rearranged in one or more different orders, and the arrangement of the functions, modules and elements may be rearranged into one or more different arrangements. Further, note that the controller 71 may optionally include some or all of the structure and/or function of the taxi operation support module 122 and/or of the indication module 124.

As used herein, a “module” may include hardware and/or software, including executable instructions, for receiving one or more inputs, processing the one or more inputs, and providing one or more corresponding outputs. Also note that at some points throughout the present disclosure, reference may be made to a singular input, output, element, etc., while at other points reference may be made to plural/multiple inputs, outputs, elements, etc. Thus, weight should not be given to whether the input(s), output(s), element(s), etc. are used in the singular or plural form at any particular point in the present disclosure, as the singular and plural uses of such words should be viewed as being interchangeable, unless the specific context dictates otherwise.

The above description is intended to be illustrative, and not restrictive. While the dimensions and types of materials described herein are intended to be illustrative, they are by no means limiting and are exemplary embodiments. In the following claims, use of the terms “first”, “second”, “top”, “bottom”, etc. are used merely as labels, and are not intended to impose numerical or positional requirements on their objects. As used herein, an element or step recited in the singular and preceded by the word “a” or “an” should be understood as not excluding plural of such elements or steps, unless such exclusion is explicitly stated. Additionally, the phrase “at least one of A and B” and the phrase “A and/or B” should each be understood to mean “only A, only B, or both A and B”. Moreover, unless explicitly stated to the contrary, embodiments “comprising” or “having” an element or a plurality of elements having a particular property may include additional such elements not having that property. And when broadly descriptive adverbs such as “substantially” and “generally” are used herein to modify an adjective, these adverbs mean “mostly”, “mainly”, “for the most part”, “to a significant extent”, “to a large degree” and/or “at least 51 to 99% out of a possible extent of 100%”, and do not necessarily mean “perfectly”, “completely”, “strictly”, “entirely” or “100%”. Additionally, the word “proximate” may be used herein to describe the location of an object or portion thereof with respect to another object or portion thereof, and/or to describe the positional relationship of two objects or their respective portions thereof with respect to each other, and may mean “near”, “adjacent”, “close to”, “close by”, “at” or the like.

This written description uses examples, including the best mode, to enable those skilled in the art to make and use devices, systems and compositions of matter, and to perform methods, according to this disclosure. It is the following claims, including equivalents, which define the scope of the present disclosure.

What is claimed is:

1. A method for an aircraft at an airport surrounded by an environment, the aircraft having a first engine and a second engine, wherein the second engine is to be started after the first engine, the method comprising:
determining a minimum amount of warm-up time needed for starting the second engine to meet predetermined start-up requirements for the second engine, based on one or more of engine-related information relating to the second engine, aircraft-related information relating to the aircraft, airport-related information relating to the airport, and environment-related information relating to the environment; and
producing an alert based on the minimum amount of warm-up time needed.

2. The method of claim 1, wherein the one or more of engine-related information, aircraft-related information, airport-related information and environment-related information includes one or both of historical information and real-time information.

3. The method of claim 1, wherein one or both of the engine-related information and the aircraft-related information includes one or both of:
instantial information relating to the second engine itself or to the aircraft itself; and
categorical information relating to an engine category to which the second engine belongs or to an aircraft category to which the aircraft belongs.

4. The method of claim 1, wherein the start-up requirements for the second engine include one or more of a minimum engine temperature, a minimum fuel temperature, a minimum oil temperature and a minimum oil pressure.

5. The method of claim 1, wherein the alert is one or more of a visual indication on a display device, an auditory indication through an auditory device, and a vibratory indication from a vibrational device.

6. The method of claim 1, wherein the alert is one or more of:
an indicator of the minimum amount of warm-up time needed;
a countdown based on the minimum amount of warm-up time needed; and
a prompt to start the second engine.

7. The method of claim 1, wherein the alert is configured for being provided for a pilot of the aircraft in one or more of:
a display device within a cockpit of the aircraft or in a heads-up display of the pilot;
an auditory device within the cockpit or in a headset of the pilot; and
a vibrational device in a steering yoke, a throttle lever, a control stick, a control pedal, a footrest or a seat within the cockpit.

8. The method of claim 1, further comprising:
receiving or accessing a first set of information relating to the one or more of engine-related information, aircraft-related information, airport-related information and environment-related information.

9. The method of claim 1, further comprising:
receiving or accessing a second set of information relating to the start-up requirements.

10. The method of claim 1, further comprising:
starting the first engine.

11. The method of claim 10, further comprising:
conducting a reduced-engine taxiing operation of the aircraft utilizing the first engine.

12. The method of claim 1, further comprising, after the step of producing the alert based on the minimum amount of warm-up time needed:
starting the second engine.

13. The method of claim 1, further comprising:
determining whether a reduced-engine taxiing operation of the aircraft is permissible based on standard operating procedures of the airport.

14. A method for performing a reduced-engine taxiing operation of an aircraft at an airport surrounded by an environment, the aircraft having a first engine and a second engine, wherein the second engine is to be started after the first engine, the method comprising:
starting the first engine;
conducting a reduced-engine taxiing operation of the aircraft utilizing the first engine;
receiving or accessing a first set of information relating to the one or more of engine-related information relating to the second engine, aircraft-related information relating to the aircraft, airport-related information relating to the airport and environment-related information relating to the environment;
receiving or accessing a second set of information relating to predetermined start-up requirements for the second engine;
determining a minimum amount of warm-up time needed for starting the second engine to meet the predetermined start-up requirements for the second engine, based on one or more of the engine-related information, aircraft-related information, airport-related information, and environment-related information; and
producing an alert based on the minimum amount of warm-up time needed.

15. The method of claim 14, wherein the one or more of engine-related information, aircraft-related information, airport-related information and environment-related information includes one or both of historical information and real-time information, and wherein one or both of the engine-related information and the aircraft-related information includes one or both of instantial information relating to the second engine itself or to the aircraft itself and categorical information relating to an engine category to which the second engine belongs or to an aircraft category to which the aircraft belongs.

16. The method of claim 14, wherein the start-up requirements for the second engine include one or more of a minimum engine temperature, a minimum fuel temperature, a minimum oil temperature and a minimum oil pressure.

17. The method of claim 14, wherein the alert comprises:
one or more of a visual indication on a display device, an auditory indication through an auditory device, and a vibratory indication from a vibrational device; and
one or more of an indicator of the minimum amount of warm-up time needed, a countdown based on the minimum amount of warm-up time needed and a prompt to start the second engine.

18. A system for supporting a taxiing operation of an aircraft at an airport surrounded by an environment, the aircraft having a first engine and a second engine wherein the second engine is to be started after the first engine, the system comprising:
a taxi operation support module having a memory configured to store an instruction set and processing circuitry configured to access the memory and execute the instruction set to:
determine a minimum amount of warm-up time needed for starting the second engine to meet predetermined start-up requirements for the second engine, based on one or more of engine-related information, aircraft-related information, airport-related information, and environment-related information; and
produce an alert signal based on the minimum amount of warm-up time needed; and
an indication module operatively connected with the taxi operation support module and configured to receive the alert signal and produce an alert based on the alert signal.

19. The system of claim 18, wherein the taxi operation support module is further configured to:
receive or access a first set of information relating to the one or more of engine-related information, aircraft-related information, airport-related information and environment-related information; and
receive or access a second set of information relating to the start-up requirements.

20. The system of claim 18, wherein the alert comprises:
one or more of a visual indication on a display device, an auditory indication through an auditory device, and a vibratory indication from a vibrational device; and
one or more of an indicator of the minimum amount of warm-up time needed, a countdown based on the minimum amount of warm-up time needed and a prompt to start the second engine.
